(19) United States
(12) Patent Application Publication
(10) Pub. No.: US 2006/0122751 A1
(43) Pub. Date: Jun. 8, 2006

(54) Vehicle steering apparatus

(75) Inventors: Yasuharu Oyama, Wako-shi (JP); Shoichi Sano, Tokyo (JP)

Correspondence Address: RANKIN, HILL, PORTER & CLARK LLP, 4080 ERIE STREET, WILLOUGHBY, OH, 44094-7836, US

(73) Assignee: Honda Motor Co., Ltd., Tokyo (JP)

(21) Appl. No.: 11/294,091

(22) Filed: Dec. 5, 2005

(30) Foreign Application Priority Data
Dec. 6, 2004 (JP) 2004-353037

(51) Int. Cl. B62D 5/04

(52) U.S. Cl. 701/41; 180/446

(57) ABSTRACT

A vehicle steering apparatus includes a steering wheel, a steering angle sensor, a turning drive mechanism for changing the direction of front wheels, and an ECU for driving the turning drive mechanism in correspondence with a steering signal. The ECU has a phase advance factor part for adding a phase advance component to the steering signal and a subtracting part for applying a behavior quantity signal outputted from a vehicle behavior sensor as a feedback signal to the output signal of the phase advance factor part.

### FIELD OF THE INVENTION

The present invention relates to a vehicle steering apparatus of an electronic control type such as a steer-by-wire type that freely controls a steered or turning angle of steered wheels in accordance with a steering input from an operating device such as a steering wheel.

### BACKGROUND OF THE INVENTION

In a conventional steering control apparatus, as disclosed in JP-A-10-264838, when a driver performs a steering operation by turning a steering wheel, that steering content is converted into an electronic signal. This electronic signal is converted by an electronic control unit into a control signal. This control signal is supplied to a steered wheel drive apparatus that controls or adjusts the steered angle of steered wheels (also often called “turning angle” or “front wheel turning angle”). With a steering angle applied using the steering wheel as a target steering angle and a steered angle of the steered wheels detected with a steered angle sensor as an actual steer angle, the electronic control unit performs feedback control to make the actual steering angle approach the target steering angle. A characteristic feature of the steering control apparatus is that a feedback-controlled gain is adjusted in correspondence with a travel state of the vehicle to effect optimal steering control. More specifically, a steering gain is made to vary with a vehicle speed V, a steering angle θ and a road surface μ to execute optimal turning control.

In a steering system that varies a wheel turn angle in correspondence with variation in a steering angle, generally the steering gain is increased in proportion with the size of the steering angle and the steering gain is decreased as the vehicle speed increases from a low speed to a high speed.

With this steering system, for executing an emergency avoidance action at a high vehicle speed, the steering wheel angle (steering angle) required is too large, and the driver cannot accomplish emergency avoidance actions.

Although emergency avoidance can be made possible by making the steering speed fast and making the steering gain large even when the steering wheel angle (steering angle) required of the steering system is small, the steering gain during normal travel (steady gain) becomes too large and raises the tension of the driver and leads to a deterioration in steering feeling.

This phenomenon is caused by the steering gain falling below the steady gain generally when the steering system is in a high-frequency region of a frequency corresponding to the steering speed at times of emergency avoidance (there is the relationship that the frequency is high when the steering speed is high).

The steering control apparatus disclosed in JP-A-10-264838 varies a turn angle ratio and adjusts the steering gain in correspondence with the vehicle speed, but because it is gain change corresponding with vehicle speed, it cannot fulfil applications where there is a need to make it correspond to variation in the steering speed (frequency) such as at times of emergency avoidance.

### SUMMARY OF THE INVENTION

According to the present invention, there is provided a vehicle steering apparatus including: an operating device steer-operated by a driver; operation state level detecting means for detecting an operation state level of the operating device; a turning actuator for changing the direction of steered wheels; control means for driving the turning actuator in correspondence with a steering signal pertaining to the operation state level outputted from the operation state level detecting means; phase component adjusting means for adding a phase advance component to the control signal outputted by the operation state level detecting means; behavior quantity detecting means for detecting a behavior quantity of the vehicle; and signal applying means for applying a behavior quantity signal outputted by the behavior quantity detecting means to the output signal of the phase component adjusting means as a feedback signal.

In this vehicle steering apparatus, a signal generated by adding a phase advance component to and also applying a behavior quantity signal as a feedback signal to a steering signal pertaining to an operation state level outputted from operation state level detecting means is supplied to control means to drive a turning actuator. Thus, the steered angle of steered wheels is decided taking into account a phase advance factor of the steering signal and a behavior state of the vehicle.

The behavior quantity of the vehicle is preferably a yaw rate or a sideways acceleration.

A phase advance component is added to a steering signal pertaining to a steering angle and also yaw rate or sideways acceleration behavior quantity is fed back to generate a control signal.

By this means, at times of normal travel a steering responsiveness easy for the driver to handle is maintained, and at times of emergency avoidance the responsiveness is raised and easy and precise avoidance steering can be performed without an excessive steering angle being required as in normal steering.

### BRIEF DESCRIPTION OF THE DRAWINGS

A preferred embodiment of the present invention will be described in detail below, by way of example, with reference to the accompanying drawings, in which:

FIG. 1 is a schematic view of a vehicle steering apparatus according to the present invention; and

FIG. 2 is a block diagram of a control system of the vehicle steering apparatus.

### DETAILED DESCRIPTION OF THE PREFERRED EMBODIMENT

A preferred embodiment of the invention will now be described on the basis of the accompanying drawings.

In this preferred embodiment, an operating device, operation state level detecting means, a turning actuator, control means, phase component adjusting means, behavior quantity detecting means and signal applying means are respectively constituted as a steering wheel, a steering angle sensor, a turning drive mechanism, an ECU (Electronic Control Unit), a phase advance factor part, a vehicle behavior sensor and a subtracting part.

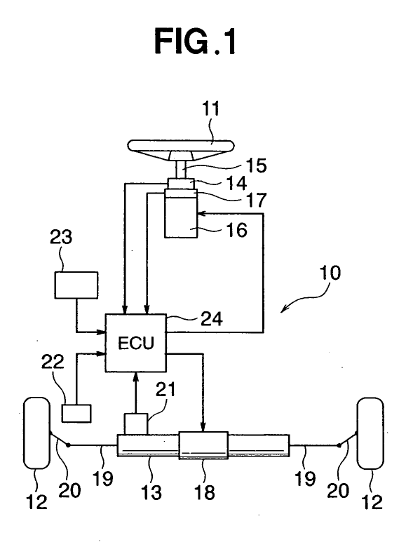

FIG. 1 shows the schematic apparatus construction of a vehicle steering apparatus according to a preferred embodiment of the invention.

A vehicle steering apparatus 10 is a vehicle steering apparatus of an electronic control type capable of freely controlling the steered angle (meaning the same as turn angle) of front wheels 12, which are steered wheels, with respect to a steering input of a steering device 11 (hereinafter called the steering wheel 11′).

When a driver turns the steering wheel 11, the rotation angle (steering angle) of the steering wheel 11 resulting from the operation of the driver is converted via a turning drive mechanism 13 into a corresponding steered angle at the front wheels 12 on the basis of a control function of an electronic control system. By the driver operating the steering wheel 11, information pertaining to a vehicle motion (or vehicle forward orientation) desired by the driver himself is inputted to the electronic control system. The rotation angle (steering angle) of the steering wheel 11 is detected by a steering angle sensor 14.

The steering angle sensor 14, a steering reaction applying motor 16 and a steering torque sensor 17 are mounted on a steering shaft 15 of the steering wheel 11.

The steering reaction applying motor 16 applies a steering reaction to the driver via the steering shaft 15 and the steering wheel 11. Because as described above the steering wheel 11 is not connected to the front wheels 12 by a mechanical structure, when the steering wheel is operated it is necessary for a steering reaction to be applied as the steering feeling of the driver.

The steering torque sensor 17 detects a steering torque arising when the driver operates the steering wheel 11 against the steering reaction created by the steering reaction applying motor 16.

The two front wheels 12 are disposed on either side of the turning drive mechanism 13. The turning drive mechanism 13 has a steering motor 18 for turning at its center, tie rods 19 provided extending from its ends, and knuckle arms 20 attached to the ends of the tie rods 19. The front wheels 12 are connected to the knuckle arms 20. A steered angle sensor 21 for detecting a steered angle resulting from the steering motor 18 being rotationally driven is mounted on the turning drive mechanism 13.

As other detection parts, a vehicle speed sensor 22 and a vehicle behavior sensor 23 for detecting yaw rate or sideways acceleration are provided.

An ECU (Electronic Control Unit) 24 constitutes a control system of the vehicle steering apparatus. Input factors respective to the ECU 24 are the steering angle sensor 14, the steering torque sensor 17, the steered angle sensor 21, the vehicle speed sensor 22 and the vehicle behavior sensor 23. Output factors respective to the ECU 24 are the steering reaction applying motor 16 and the steering motor for turning 18.

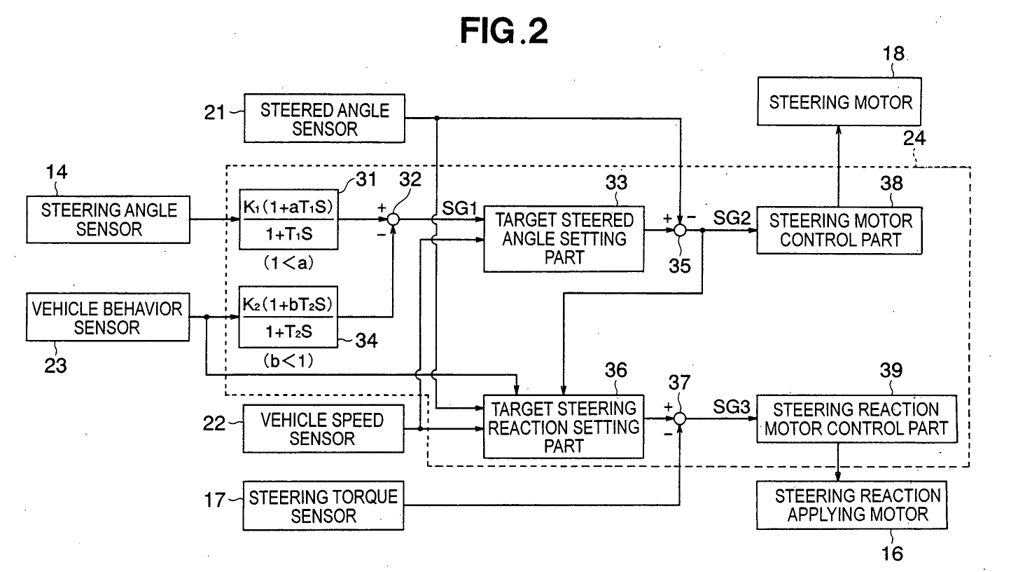

FIG. 2 shows a block construction diagram of the control system of the vehicle steering apparatus.

In FIG. 2, the ECU (shown with dashed lines) 24 constitutes a control system, and has a phase advance factor part 31, a subtracting part 32, a target steered angle setting part 33, a feedback factor part 34, a subtracting part 35, a target steering reaction setting part 36, a subtracting part 37, a steering motor control part 38 and a steering reaction motor control part 39.

A steering signal outputted from the steering angle sensor 14 goes via the phase advance factor part 31 and the subtracting part 32 and is inputted to the target steered angle setting part 33. The steering signal is a signal pertaining to the steering angle of the steering wheel 11, and has a frequency component (f) that varies in correspondence with the steering speed (steering angular speed ω=2πf).

The phase advance factor part 31 is provided with an expression K₁(1+aT₁s)/(1+T₁s), which is a transfer function of an s (Laplace transform) region of a phase advance circuit (for example a phase lead compensator). In this expression, K₁ is a gain coefficient, T₁ is a time constant, s is a Laplace operator, and ais a constant of proportionality set with the condition that 1<a.

he transfer function {K₁(1+aT₁s)/(1+T₁s)} outputs a steering signal with a low gain with respect to a steering signal of which the steering speed is slow (the frequency f is low) and a high gain with respect to a steering signal of which the steering speed is fast (the frequency f is high).

The behavior signal outputted from the vehicle behavior sensor 23 is inputted via the feedback factor part 34. The behavior signal is a signal pertaining to yaw rate or a signal pertaining to a sideways acceleration.

The feedback factor part 34 is provided with the expression K₂(1+bT₂s)/(1+T₂s), which is a transfer function of an s (Laplace transform) region of an integrating circuit. In this expression, K₂ is a gain constant, T₂ is a time constant, s is a Laplace operator, and b is a constant of proportionality set with the condition that b<1.

As the feedback factor part 34, generally, acceleration, speed and position are fed back from information on acceleration and speed, and it is set as a constant or integral-type factor. The expression given above is expressed as a general form for realizing this feedback factor. Depending on how b and T above are selected it can be made to vary in a characteristic from a constant to an integral factor.

A feedback path is formed by a signal pertaining to the behavior (yaw rate or sideways acceleration) of the vehicle detected with the vehicle behavior sensor 23 being supplied to the subtracting part 32 via the feedback factor part 34.

The subtracting part 32 subtracts the behavior signal having passed through the feedback factor part 34 from the steering signal having passed through the phase advance factor part 31 and supplies a deviation signal SG1 to the target steered angle setting part 33.

The deviation signal SG1 and a vehicle speed signal from the vehicle speed sensor 22 are inputted to the target steered angle setting part 33. In correspondence with the vehicle speed signal supplied to it from the vehicle speed sensor 22, with the deviation signal SG1 as a target value signal the target steered angle setting part 33 sets a target steered angle corresponding to the steering angle of the steering wheel 11 and supplies this target steered angle signal to the subtracting part 35.

The subtracting part 35 subtracts from the target steered angle signal a signal pertaining to an actual steered angle outputted from the steered angle sensor 21 and supplies a deviation signal SG2 to the steering motor control part 38.

The target steering reaction setting part 36 sets a target value of steering reaction for driving the steering reaction applying motor 16 and applying a steering reaction to the steering wheel 11.

The vehicle speed signal from the vehicle speed sensor 22, the signal pertaining to the actual steered angle from the steered angle sensor 21, the signal pertaining to the vehicle behavior (sideways acceleration, yaw rate) from the vehicle behavior sensor 23, and the deviation signal SG2 outputted from the subtracting part 35 are inputted to the target steering reaction setting part 36.

On the basis of the vehicle speed signal, the signal pertaining to the actual steered angle, the signal pertaining to the vehicle behavior and the deviation signal SG2, the target steering reaction setting part 36 sets a target value of the steering reaction. Feeding back signals pertaining to vehicle drive to the driver in correspondence with a reaction helps to support optimal driving of the driver. A signal pertaining to a target steering reaction outputted from the target steering reaction setting part 36 is supplied to the subtracting part 37.

The subtracting part 37 subtracts from the signal pertaining to a target steering reaction a signal pertaining to the actual steering torque outputted from the steering torque sensor 17 and supplies a deviation signal SG3 to the steering reaction motor control part 39.

The steering motor control part 38, on the basis of the deviation signal SG2 supplied to it from the subtracting part 35, controls the steering motor 18 of the turning drive mechanism 13 so that the steered angle of the front wheels 12 approaches the target steered angle. This control is executed so that the deviation signal SG2 becomes zero.

The steering reaction motor control part 39, on the basis of the deviation signal SG3 supplied to it from the subtracting part 37, controls the steering reaction applying motor 16 so that the steering torque approaches the target steering torque. This control is executed so that the deviation signal SG3 becomes zero.

As described above, the steering control system of a vehicle steering apparatus according to this preferred embodiment is constructed to add a phase advance factor from a phase advance factor part 31 to a signal pertaining to a steering angle of the steering wheel 11 inputted to the target steered angle setting part 33 and also to feed back a vehicle behavior by means of the feedback factor part 34 and the subtracting part 32.

As a result, in a high-frequency region corresponding to operation of the steering wheel 11 at a fast steering speed, for example in a steering wheel operation with a fast movement in an emergency avoidance maneuver or the like while the vehicle is traveling, the gain of the steering control system can be raised greatly without the stability of the system being lost, and it is possible to realize high responsiveness.

This is because in the setting of the phase advance for the steering angle from the steering wheel 11, a vehicle behavior such as yaw rate or sideways acceleration is taken into consideration by being fed back and applied. By this means it is possible to realize high-speed responsiveness together with stable responsiveness.

For example, in a traffic lane change made as an emergency avoidance to avoid an obstruction, the response of sideways acceleration is important, and with respect to operation of the steering wheel the faster the steering input speed (steering speed) is the better.

In steering wheel operation under general test conditions, as a common steering speed of a driver 500°/second is a maximum inputtable steering speed, and as the steering speed of a special test driver 1000°/second is a maximum inputtable steering speed.

Therefore, to evaluate the emergency avoidance capability of the control system of a vehicle steering apparatus, a sideways acceleration gain at steering input speed 500°/second to 1000°/second should be focused upon.

In this connection, for example, for a standard small passenger car, when optimal values of the above-mentioned constants K₁, T₁, a of the phase advance factor part transfer function K₁(1+aT₁s)/(1+T₁s) and the constants K₂, T₂, b of the feedback factor transfer function K₂(1+bT₂s)/(1+T₂s) of the steering system were obtained so that an avoidance manoeuver in a minimum distance is possible at a vehicle speed of 72 km/h and variation of sideways acceleration response gain corresponding to steady state steering speeds of (steering angular speed=2πf) 500°/second and 1000°/second were calculated, the results shown in Table 1 were obtained.

TABLE 1

| | GAIN CHANGE FROM | |
|---|---|---|
| | STEADY STATE (dB) | |
| CONTENT | 500°/sec | 1000°/sec |
| steering system of related art that perform | −12.3 | −10.6 |
| no special control | | |
| steering system that adds phase advance | 0.8 | −0.7 |
| factor to steering wheel steering angle and | | |
| also performs feedback of yaw rate | | |
| steering system that adds phase advance | 17.3 | 15.2 |
| factor to steering wheel steering angle and | | |
| also performs feedback of sideways | | |
| acceleration | | |

As is clear from Table 1, with a vehicle steering apparatus according to the invention, compared to a steering system of related art, it is possible to ameliorate the fall in gain at steering input speeds of times of emergency avoidance and achieve an increase in gain, and it is possible to realize a steering responsiveness that is easy for the driver to handle during normal travel and a high-speed responsiveness at times of emergency avoidance.

Obviously, various minor changes and modifications of the present invention are possible in the light of the above teaching. It is therefore to be understood that within the scope of the appended claims the invention may be practiced otherwise than as specifically described.

What is claimed is:

1. A vehicle steering apparatus, comprising:
an operating device steer-operated by a driver;
operation state level detecting means for detecting an operation state level of the operating device;
a turning actuator for changing the direction of steered wheels;
control means for driving the turning actuator in correspondence with a steering signal pertaining to the operation state level outputted from the operation state level detecting means;
phase component adjusting means for applying a phase advance component to the steering signal outputted by the operation state level detecting means;
behavior quantity detecting means for detecting a behavior quantity of the vehicle; and
signal applying means for applying a behavior quantity signal outputted by the behavior quantity detecting means to an output signal of the phase component adjusting means as a feedback signal.

2. A vehicle steering apparatus according to claim 1, wherein said behavior quantity of the vehicle is a yaw rate or a sideways acceleration.
